(19) United States
(12) Patent Application Publication
(10) Pub. No.: US 2016/0114723 A1
(43) Pub. Date: Apr. 28, 2016

(54) Electronic Display Device

(71) Applicant: Daniel Shipley, Greenwood, IN (US)

(72) Inventor: Daniel Shipley, Greenwood, IN (US)

(21) Appl. No.: 14/523,082

(22) Filed: Oct. 24, 2014

(51) Int. Cl. B60Q 1/44; G09G 5/00; B60Q 1/30; G06F 3/02

(52) U.S. Cl. CPC B60Q 1/44; G06F 3/02; G09G 5/006; B60Q 1/30; G09G 2370/16

(57) ABSTRACT

An electronic display assembly includes a tailgate retrofitted to a vehicle. A primary display is coupled to the tailgate. A control panel is positioned within the vehicle such that the control panel is accessible to a user. A processor is coupled to the control panel and the primary display. A keyboard is coupled to the control panel and the processor to enter text into the processor. The processor communicates the text to the primary display. A brake sensor is coupled to the control panel and the processor. The brake sensor is electrically coupled to the vehicle braking system wherein the brake sensor detects when the user engages the vehicle braking system. Thus, the primary display issues a visual alert to the observer when the user engages the vehicle braking system. A secondary display is coupled to the control panel and the processor such that the secondary display displays the text.

### BACKGROUND OF THE DISCLOSURE

### Field of the Disclosure

The disclosure relates to display devices and more particularly pertains to a new display device for displaying an electronic message on a vehicle.

### SUMMARY OF THE DISCLOSURE

An embodiment of the disclosure meets the needs presented above by generally comprising a tailgate coupled to a vehicle. A primary display is coupled to the tailgate such that the primary display is visible to an observer. A control panel is positioned within the vehicle such that the control panel is accessible to a user. A processor is coupled to the control panel. The processor is electrically coupled to the primary display. A keyboard is coupled to the control panel. The keyboard is electrically coupled to the processor such that the keyboard enters text into the processor. The processor communicates the text to the primary display wherein the primary display displays the text. A brake sensor is coupled to the control panel. The brake sensor is electrically coupled to the processor. The brake sensor is electrically coupled to the vehicle braking system wherein the brake sensor detects when the user engages the vehicle braking system. Thus, the primary display issues a visual alert to the observer when the user engages the vehicle braking system. A secondary display is coupled to the control panel. The secondary display is electrically coupled to the processor such that the secondary display displays the text.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a electronic display assembly according to an embodiment of the disclosure.

FIG. 2 is a perspective view of an embodiment of the disclosure.

FIG. 3 is an in-use view of an embodiment of the disclosure.

FIG. 4 is a schematic view of an embodiment of the disclosure.

FIG. 5 is a side perspective view of an alternative embodiment of the disclosure.

### DESCRIPTION OF THE PREFERRED EMBODIMENT

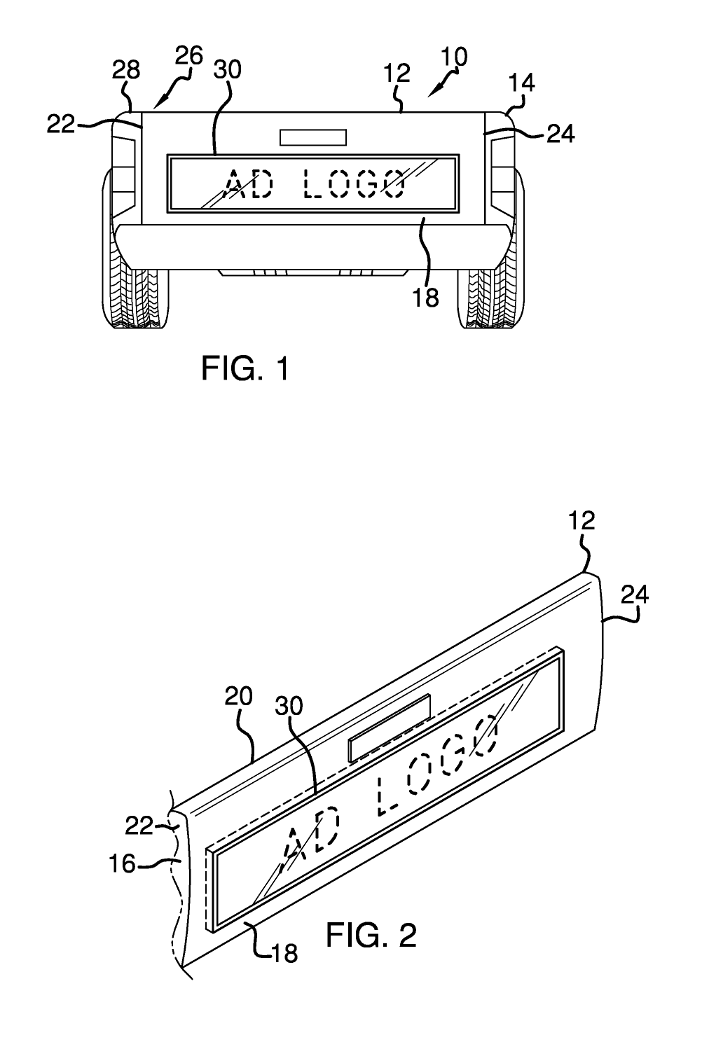

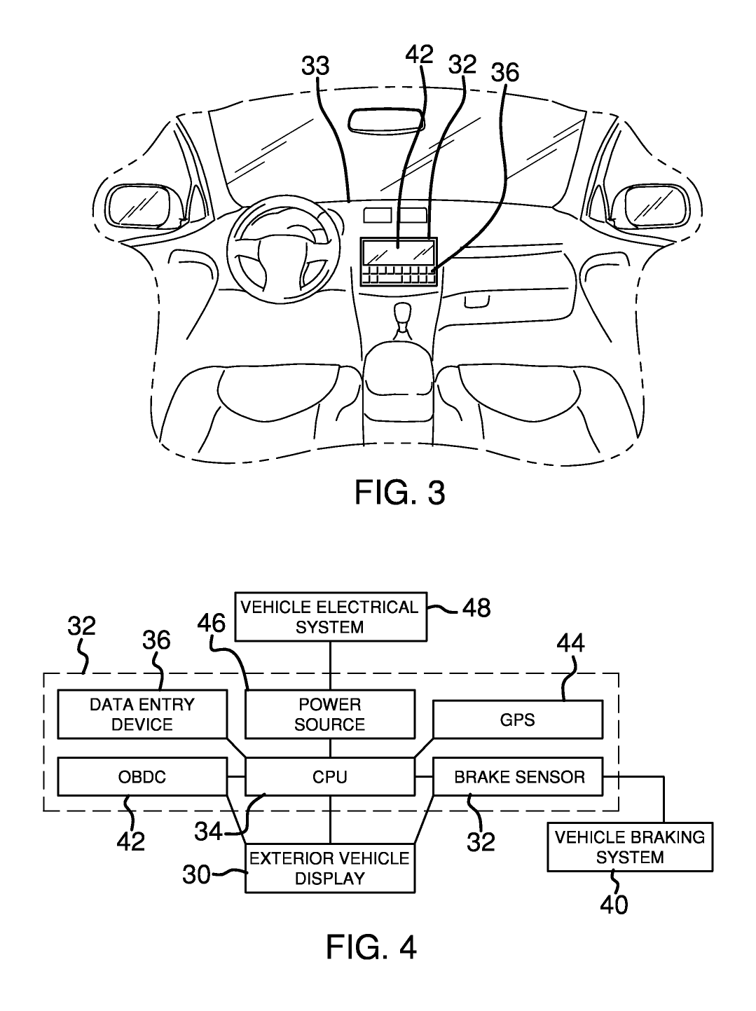

With reference now to the drawings, and in particular to FIGS. 1 through 5 thereof, a new display device embodying the principles and concepts of an embodiment of the disclosure and generally designated by the reference numeral 10 will be described.

As best illustrated in FIGS. 1 through 5, the electronic display assembly 10 generally comprises a tailgate 12 that may be coupled a vehicle 14. The vehicle 14 may be a pickup or the like. The tailgate 12 has an outer side 16 extending between each of a front side 18 and a back side 20 of the tailgate 12. Each of a first lateral side 22 and a second lateral side 24 of the outer side 16 is movably coupled to a rear 26 of a bed 28 of the vehicle 14 such that the front side 18 of the tailgate 12 is visible to an observer.

A primary display 30 is provided. The primary display 30 is coupled to the front side 18 of the tailgate 12. The primary display 30 is recessed into the front side 18 of the tailgate 12 wherein the primary display 30 is visible to the observer. The primary display 30 extends between the first lateral side 22 and the second lateral side 24 of the tailgate 12. Additionally, the primary display 30 may be a LED display or the like.

A control panel 32 is provided. The control panel 32 is coupled to a dashboard 33 of the vehicle 14 such that the control panel 32 is accessible to a user. A processor 34 is coupled to the control panel 32. The processor 34 is electrically coupled to the primary display 30. The processor 34 may be an electronic processor or the like.

An input 36 is coupled to the control panel 32 so the input 36 is accessible to the user. The input 36 is electrically coupled to the processor 34 such that the input 36 communicates text to the processor 34. The processor 34 communicates the text to the primary display 30 wherein the primary display 30 displays the text. The input 36 may be querty keyboard or the like.

A brake sensor 38 is coupled to the control panel 32. The brake sensor 38 is electrically coupled to the processor 34. The brake sensor 38 is electrically coupled to the vehicle's braking system 40 to detect when the user engages the vehicle's braking system 40. The primary display 30 issues a visual alert to the observer when the user engages the vehicle braking system 40. The visual alert may be a flashing image or other similar visual alert.

A secondary display 42 is coupled to the control panel 32. The secondary display 42 is electrically coupled to the processor 34 such that the secondary display 42 displays the text. A gps 44 is provided. The gps 44 is coupled to the control panel 32. Additionally, the gps 44 is electrically coupled to the processor 34. The gps 44 allows the control panel 32 to determine a physical location of the vehicle 14.

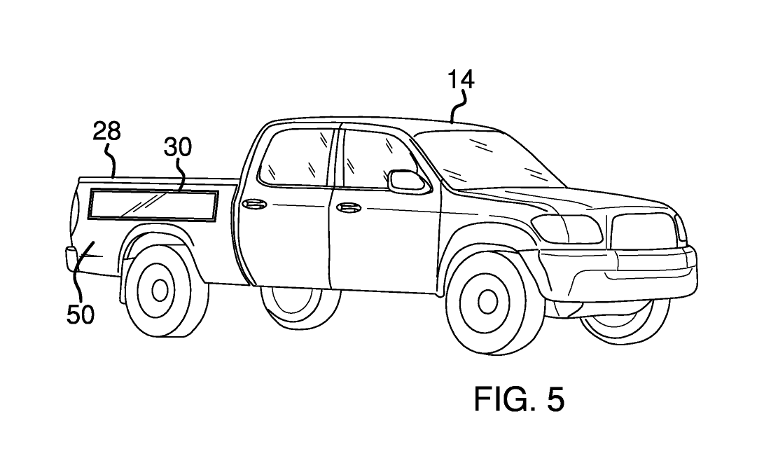

A power supply 46 is coupled to the control panel 32. The power supply 46 is electrically coupled to the processor 34. The power supply 46 is electrically coupled to the vehicle electrical system 48. In an alternative embodiment as shown in FIG. 5, the primary display 30 may be coupled to a first oblique side 50 of the bed 28 of the vehicle 14. The primary display 30 is positioned to be visible to the observer.

In use, the tailgate 12 is retrofitted to the vehicle 14 for the use of advertising, promotional uses or other similar communication activities. The user enters the desired text into the processor 34. Additionally, the primary display 30 may be utilized in the event of a mechanical problem with the vehicle 14 to alert the observer to the presence of the vehicle 14 or to request assistance with the mechanical problem.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electronic display assembly comprising:
a tailgate configured to be coupled to a vehicle;
a primary display coupled to said tailgate such that said primary display is visible to an observer;
a control panel configured to be positioned within the vehicle such that said control panel is accessible to a user;
a processor coupled to said control panel, said processor being electrically coupled to said primary display;
an input coupled to said control panel, said input being electrically coupled to said processor such that said input enters text into said processor, said processor communicating said text to said primary display wherein said primary display displays said text;
a brake sensor coupled to said control panel, said brake sensor being electrically coupled to said processor, said brake sensor being electrically coupled to the vehicle braking system wherein said brake sensor is configured to detect when the user engages the vehicle braking system such that said primary display issues a visual alert to the observer when the user engages the vehicle braking system; and
a secondary display coupled to said control panel, said secondary display being electrically coupled to said processor such that said secondary display displays said text.

2. The assembly according to claim 1, wherein said tailgate having an outer side extending between each of a front side and a back side of said tailgate, each of a first lateral side and a second lateral side of said outer side being movably coupled to a rear of a bed of the vehicle such that said front side of said tailgate is visible to the observer, said primary display being recessed into said front side of said tailgate.

3. The assembly according to claim 1, further comprising a GPS coupled to said control panel, said GPS being electrically coupled to said processor.

4. The assembly according to claim 1, further comprising a power supply coupled to said control panel, said power supply being electrically coupled to said processor, said power supply being electrically coupled to the vehicle electrical system.

5. An electronic display assembly comprising:
a tailgate configured to be retrofitted to a vehicle, said tailgate having an outer side extending between each of a front side and a back side of said tailgate, each of a first lateral side and a second lateral side of said outer side being movably coupled to a rear of a bed of a vehicle such that said front side of said tailgate is visible to the observer;
a primary display coupled to said front side of said tailgate such that said primary display is recessed into said front side of said tailgate wherein said primary display is visible to an observer;
a control panel configured to be positioned within the vehicle such that said control panel is accessible to a user;
a processor coupled to said control panel, said processor being electrically coupled to said primary display;
a input coupled to said control panel, said input being electrically coupled to said processor such that said input enters text into said processor, said processor communicating said text to said primary display wherein said primary display displays said text;
a brake sensor coupled to said control panel, said brake sensor being electrically coupled to said processor, said brake sensor being electrically coupled to the vehicle braking system such that said primary display issues a visual alert to the observer when the user engages the vehicle braking system;
a secondary display coupled to said control panel, said secondary display being electrically coupled to said processor such that said secondary display displays said text;
a GPS coupled to said control panel, said GPS being electrically coupled to said processor; and
a power supply coupled to said control panel, said power supply being electrically coupled to said processor, said power supply being electrically coupled to the vehicle electrical system.
